(19) United States
(12) Patent Application Publication
(10) Pub. No.: US 2026/0208588 A1
(43) Pub. Date: Jul. 23, 2026

(54) DISPLAY CONTROL DEVICE, DISPLAY CONTROL METHOD, AND STORAGE MEDIUM

(71) Applicant: TOYOTA JIDOSHA KABUSHIKI KAISHA, Toyota-shi Aichi-ken (JP)

(72) Inventor: Satoshi Naito, Toyota-shi Aichi-ken (JP)

(73) Assignee: TOYOTA JIDOSHA KABUSHIKI KAISHA, Toyota-shi Aichi-ken (JP)

(21) Appl. No.: 19/453,408

(22) Filed: Jan. 20, 2026

(30) Foreign Application Priority Data
Jan. 23, 2025 (JP) 2025-010085

(51) Int. Cl. B60K 35/81; B60K 35/22; B60K 35/28; B60K 35/29

(52) U.S. Cl. CPC B60K 35/81; B60K 35/22; B60K 35/28; B60K 35/29; B60K 2360/115; B60K 2360/119; B60K 2360/164; B60K 2360/166

(57) ABSTRACT

Short cut buttons are made to be displayed on the basic screen of the display device. A plurality of candidates for functions to be assigned to the short cut buttons are displayed on a function selection screen of the display device and a user is made to select functions to be assigned to the short cut buttons. The functions are comprised of either compulsory setting type functions which are compulsorily set on or off when the power of the vehicle is turned on regardless of the on/off settings of the functions when the power was turned off the previous time and setting hold type functions where the on/off settings of the functions when the power was turned off the previous time are held when the power of the vehicle is turned on. The compulsory setting type functions are preferentially displayed as the candidates of functions on the function selection screen.

### DESCRIPTION

### CROSS-REFERENCE TO RELATED APPLICATIONS

This application claims priority to Japanese Patent Application No. 2025-010085 filed January 23, 2025, the entire contents of which are herein incorporated by reference.

### FIELD

The present disclosure relates to a display control device, display control method, and storage medium.

### BACKGROUND

Known in the art is an information apparatus designed to display vehicle function buttons, that is, short cut buttons, for calling up specific functions relating to operation of a vehicle, on a menu screen of a display device mounted in the vehicle (for example, see Japanese Unexamined Patent Publication No. 2024-49711). This information apparatus is designed to acquire the frequencies of use of the different functions relating to operation of the vehicle separated into use while the vehicle is moving and while the vehicle is stopped, display function buttons, that is, short cut buttons, for calling up functions judged to be high in frequency of use while the vehicle was moving when the vehicle is moving, and display function buttons, that is, short cut buttons, for calling up functions judged to be high in frequency of use while the vehicle was stopped when the vehicle is stopped.

### SUMMARY

In this regard, in a vehicle, there are functions where the on/off settings thereof are performed by short cut buttons being pressed by a user with a high probability when the power of the vehicle is turned on, but once the short cut buttons are pressed, after that the on/off settings thereof will not be changed until the power of the vehicle is turned off. On the other hand, the functions of a vehicle include compulsory setting type functions which are compulsorily set on/off when the power of the vehicle is turned on regardless of the on/off settings of the functions when the power was turned off the previous time and setting hold type functions where the on/off settings of the functions when the power was turned off the previous time are held at the time when the power of the vehicle is turned on. In particular, the compulsory setting type functions has a strong tendency such that, if the on/off settings of the functions are performed by short cut buttons being pressed once when the power of the vehicle is turned on, after that, the on/off settings of the functions are not changed until the power of the vehicle is turned off. In embodiments, in this case, the short cut buttons for the compulsory setting type functions the on/off settings of which are performed by a high probability when the power of the vehicle is turned on are displayed from the start. However, if, like in the above known information apparatus, making short cut buttons be displayed based on the history of use, there is the problem that short cut buttons will not be displayed until a history of use is built up and therefore a user has to repeatedly perform a burdensome operation for display of short cut buttons.

The present disclosure is designed to enable the work of assigning compulsory setting type functions to short cut buttons for making short cut buttons for compulsory setting type functions be displayed without the user feeling that burdened.

According to the present disclosure, there is provided a display control device for controlling a screen display of a display device mounted in a vehicle, the display control device comprising:

a short cut button display control unit for making short cut buttons be displayed on a basic screen of the display device and

a function assigning unit for making a plurality of candidates for the functions to be assigned to the short cut buttons be displayed on a function selection screen of the display device and making a user select the functions to be assigned to the short cut buttons,

a plurality of the functions displayed on the function selection screen being comprised of either compulsory setting type functions which are compulsorily set on or off when a power of the vehicle is turned on regardless of on/off settings of the functions when the power was turned off the previous time and setting hold type functions where the on/off settings of the functions when the power was turned off the previous time are held when the power of the vehicle is turned on,

the function assigning unit making the compulsory setting type functions be preferentially displayed as the candidates of the functions on the function selection screen.

Furthermore, according to the present disclosure, there is provided a display control method for controlling a screen display of a display device mounted in a vehicle, the display control method causing a computer to

make short cut buttons be displayed on a basic screen of the display device and make a plurality of candidates for functions to be assigned to the short cut buttons be displayed on a function selection screen of the display device and make a user select the functions to be assigned to the short cut buttons, a plurality of the functions displayed on the function selection screen being comprised of either compulsory setting type functions which are compulsorily set on or off when a power of the vehicle is turned on regardless of the on/off settings of the functions when the power was turned off the previous time and setting hold type functions where the on/off settings of the functions when the power was turned off the previous time are held when the power of the vehicle is turned on, and

make the compulsory setting type functions be preferentially displayed as the candidates of the functions on the function selection screen.

Furthermore, according to the present disclosure, there is provided a storage medium storing a program used for controlling a screen display of a display device mounted in a vehicle, the program causing a computer to

make short cut buttons be displayed on a basic screen of the display device and

make a plurality of candidates for the functions to be assigned to the short cut buttons be displayed on a function selection screen of the display device and make a user select the functions to be assigned to the short cut buttons, a plurality of the functions displayed on the function selection screen being comprised of either compulsory setting type functions which are compulsorily set on or off when a power of the vehicle is turned on regardless of on/off settings of the functions when the power was turned off the previous time and setting hold type functions where the on/off settings of the functions when the power was turned off the previous time are held when the power of the vehicle is turned on, and

make the compulsory setting type functions be preferentially displayed as the candidates of the functions on the function selection screen.

It is possible to perform the work of assigning compulsory setting type functions to short cut buttons without the user feeling that burdened.

### BRIEF DESCRIPTION OF DRAWINGS

FIG. 1 is a top view of a vehicle shown schematically.

FIG. 2 is a view showing a functional configuration of a vehicle.

FIG. 3A is a view schematically showing a basic screen of a display device.

FIG. 3B is a view schematically showing a basic screen of a display device.

FIG. 4A is a view schematically showing a screen of a display device.

FIG. is a view schematically showing a screen of a display device.

FIG. 5A is a view schematically showing a screen of a display device.

FIG. 5B is a view schematically showing a screen of a display device.

FIG. 6A is a view schematically showing a screen of a display device.

FIG. 6B is a view schematically showing a screen of a display device.

FIG. 7 is a view schematically showing a screen of a display device.

FIG. 8 is a view schematically showing a screen of a display device.

FIG. 9 is a flow chart for performing processing for setting functions on/off without using short cut buttons.

FIG. 10 is a flow chart for performing processing for setting functions on/off by using short cut buttons.

FIG. 11 is a view showing a flow of assignment of functions to short cut buttons.

FIG. 12 is a flow chart for performing processing for setting compulsory setting type functions on/off when the power is turned on.

FIG. 13 is a flow chart for performing processing for selecting and displaying function candidates.

FIG. 14 is a flow chart for performing processing for setting functions on/off by using short cut buttons.

### DESCRIPTION OF EMBODIMENTS

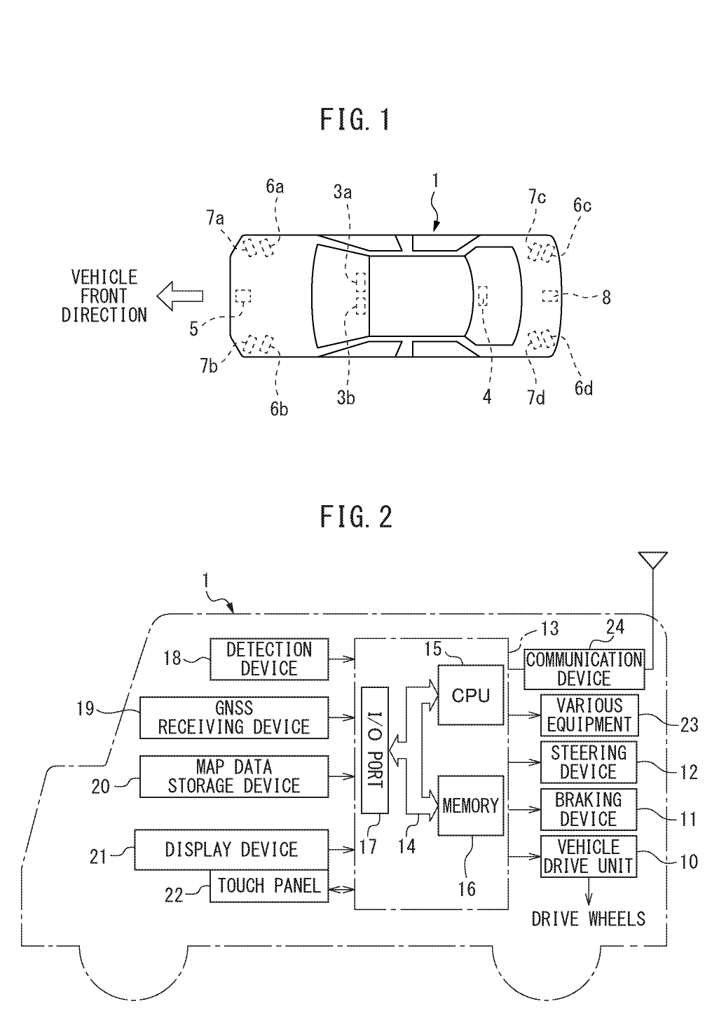

FIG. 1 schematically shows a vehicle 1 when viewed from above, while FIG. 2 shows the functional configuration of the vehicle 1 shown in FIG. 1. Note that, this vehicle 1 can be driven by either manual driving and autonomous driving. If referring to FIG. 2, 10 indicates a vehicle drive unit for imparting drive force to drive wheels of the vehicle 1, 11 indicates a braking device for braking the vehicle 1, 12 indicates a steering device for steering the vehicle 1, and 13 indicates an electronic control unit mounted in the vehicle 1. As shown in FIG. 2, the electronic control unit 13 is comprised of a digital computer and is provided with a CPU (processor) 15, a memory 16 comprised of a ROM and RAM, and an input/output port 17 which are connected with each other by a bidirectional bus 14.

On the other hand, as shown in FIG. 2, in the vehicle 1, a detection device 18 including various types of sensors required when the vehicle 1 is being manually driven or automatically driven is arranged. This detection device 18 includes sensors for detecting the state of the vehicle 1 and sensors for detecting the surroundings of the vehicle 1. In this case, as sensors for detecting the state of the vehicle 1, an acceleration sensor, speed sensor, azimuth sensor, and geomagnetic sensor are used. As sensors for detecting the surroundings of the vehicle 1, cameras for capturing the areas in front of, at the sides of, and at the back of the vehicle 1, and lidars, radars, clearance sonars, etc. for detecting the areas in front of, at the sides of, and at the back of the vehicle 1 are used.

FIG. 1 shows one example of the sensors arranged in the vehicle 1. In the example shown in FIG. 1, visible light cameras 3a, 3b for capturing the area in front of the vehicle 1, a rear camera 4 for capturing the area in back of the vehicle 1, a long distance millimeter wave radar 5 for emitting millimeter waves toward the area in front of the vehicle 1, medium distance millimeter wave radars 6a, 6b, 6c, and 6d for emitting millimeter waves toward the areas at the sides of the vehicle 1, lidars 7a, 7b, 7c, and 7d for firing laser beams toward the areas at the sides of the vehicle 1, and clearance sonar 8 for emitting ultrasonic waves toward the area in back of the vehicle 1 are arranged in the vehicle 1. Note that, the method of setting the cameras and sensors shown in FIG. 1 shown is just an example. There are various methods for arranging these cameras and sensors.

Returning again to FIG. 2, the vehicle 1 is provided with a GNSS (global navigation satellite system) receiving device 19, map data storage device 20, and display device 21. The GNSS receiving device 19 can detect a current position of the vehicle 1 (for example, the latitude and longitude of the vehicle 1) based on information obtained from a plurality of artificial satellites. Therefore, it is possible to acquire the current position of the vehicle 1 by this GNSS receiving device 19. As this GNSS receiving device 19, for example, a GPS receiving device is used. Further, in the map data storage device 20, the map data etc. necessary for the vehicle 1 to run is stored. The detection device 18, the GNSS receiving device 19, and the map data storage device 20 are connected to the electronic control unit 13.

The display device 21 is arranged inside the vehicle compartment and has a screen able to be viewed by the user of the vehicle 1, for example, the driver of the vehicle 1. A pressure sensitive type, electrostatic inductance type, or electrostatic capacity type thin film shaped touch panel 22 is integrally formed on the screen of the display device 21. These display device 21 and touch panel 22 are connected to the electronic control unit 13. Further, headlights, turn lights, inside compartment lights, an air-conditioner, and other various devices 23 are arranged in the vehicle 1. These various devices 23 are connected to the electronic control unit 13. A communication device 24 for receiving television broadcasts, radio broadcasts, traffic information, etc. and trading signals with information centers or other vehicles is mounted in the vehicle 1. This communication device 24 is connected to the electronic control unit 13.

In the example shown in FIG. 2, the vehicle drive unit 10 of the vehicle 1 is comprised of an electric motor driven by a secondary battery or an electric motor driven by a fuel cell. The drive wheels are controlled in drive by these electric motors in accordance with output signals of the electronic control unit 13. Further, the braking of the vehicle 1 is controlled by the braking device 11 in accordance with output signals of the electronic control unit 13, while the steering of the vehicle 1 is controlled by the steering device 12 in accordance with output signals of the electronic control unit 13.

First, the meanings of the terms used in this Description will be simply explained. In this Description, “power on” indicates “a state where the vehicle 1 can be controlled in drive” while “power off” indicates “a state where the vehicle 1 cannot be controlled in drive”. Further, in this Description, “function on” indicates “a state where a function is activated or a state where a function can be activated” while “function off” indicates “a state where a function is deactivated”.

Further, in this Description, “a function is set on” indicates “a function is set so that the function is activated” while “a function is set off” indicates “a function is set so that the function is deactivated”.

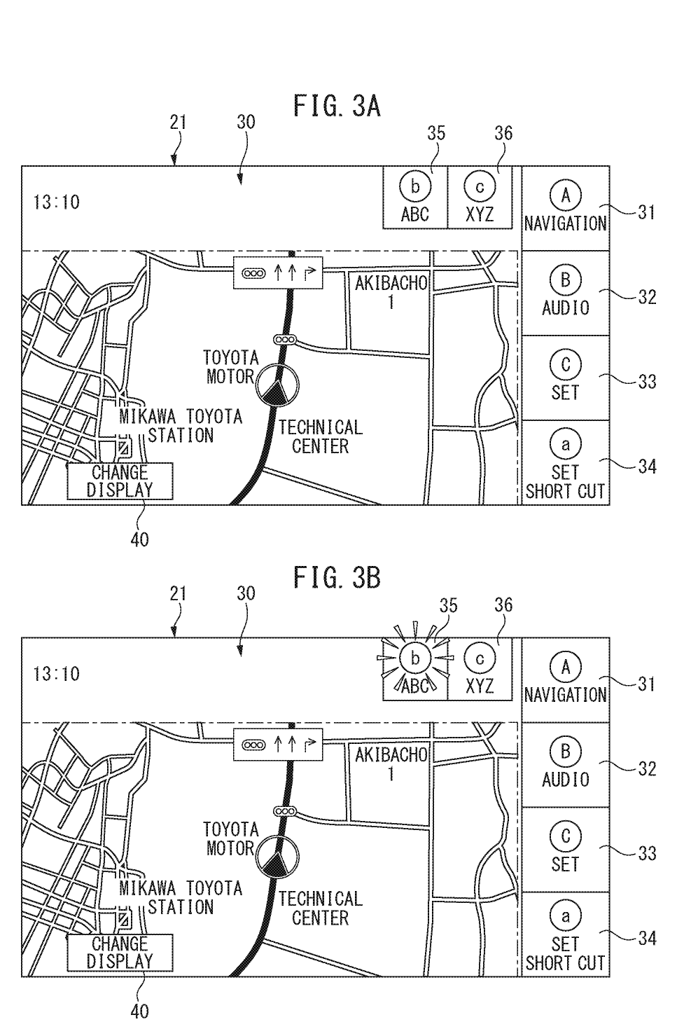

Next, referring to FIG. 3A, the screen 30 of the display device 21 used in an embodiment according to the present disclosure will be explained. If the display device 21 is started up, as shown in FIG. 3A, a button 31 for a navigation function which is one of the basic functions, a button 32 for an audio function which is one of the basic functions, and a button 33 for a setting function which is one of the basic functions are displayed on the surroundings of the screen 30 of the display device 21. At this time, as shown in FIG. 3A, for example, a road map is displayed on the screen 30 of the display device 21. In this Description, the screen 30 on which the button 31 for a navigation function which is one of the basic functions, the button 32 for an audio function which is one of the basic functions, and the button 33 for a setting function which is one of the basic functions are displayed like when the display device 21 is started up will be called a “basic screen”.

Note that, in the embodiment shown in FIG. 3A, a layer of the thin film shaped touch panel 22 is formed on the screen 30 of the display device 21. In FIG. 3A, if buttons displayed on the screen 30 such as the navigation function button 31, audio function button 32, and setting function button 33 are touched, the fact of the buttons being touched is recognized by the electronic control unit 13 through the touch panel 22. In this Description, the fact of buttons being displayed on the screen 30 so that the fact of buttons being touched is recognized by the electronic control unit 13 will be referred to simply as the buttons being displayed on the screen 30. Note that, in FIG. 3A, the marks A, B, C and letters illustrate schematically icons showing the navigation function, audio function, and setting function.

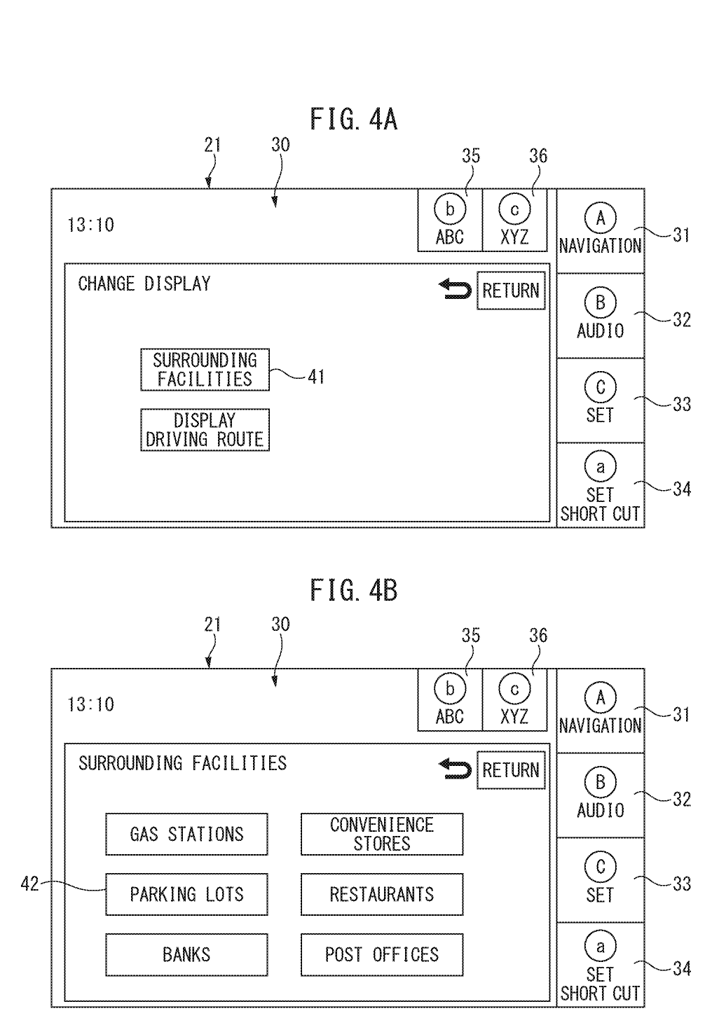

Next, one example of the button operation in these basic functions will be simply explained. FIG. 3A shows the case where the navigation function button 31 is touched and a road map is displayed on the basic screen of the display device 21. If a display changing button 40 provided on this road map is touched, the road map is switched to a display changing screen such as shown in FIG. 4A positioned one level lower. Next, if, for example, a surrounding facility button 41 which is displayed on this display changing screen is touched, the display changing screen is switched to a surrounding facility selection screen such as shown in FIG. 4B positioned one level lower. Next, if, for example, a parking lot button 42 which is displayed on this surrounding facility selection screen is touched, the screen 30 is switched to the road map screen shown in FIG. 3A and the positions of parking lots are displayed on the road map.

In this way, in this example, by the parking lot button 42 positioned at a deep level being touched, the parking lot position display function for displaying the positions of parking lots on the map is set on, the parking lot position display function is activated, and the positions of parking lots are displayed on the road map. In this case, for example, when the positions of parking lots are displayed on the road map, if the navigation function button 31 is touched, the parking lot position display function is set off and the display of the positions of the parking lots disappears from this road map. Note that, the road map screen, display changing screen, and surrounding facility selection screen respectively shown in FIGS. 3A, FIG. 4A, and FIG. 4B usually have several other buttons displayed, but in FIGS. 3A, FIG. 4A, and FIG. 4B, display of these several other buttons is omitted.

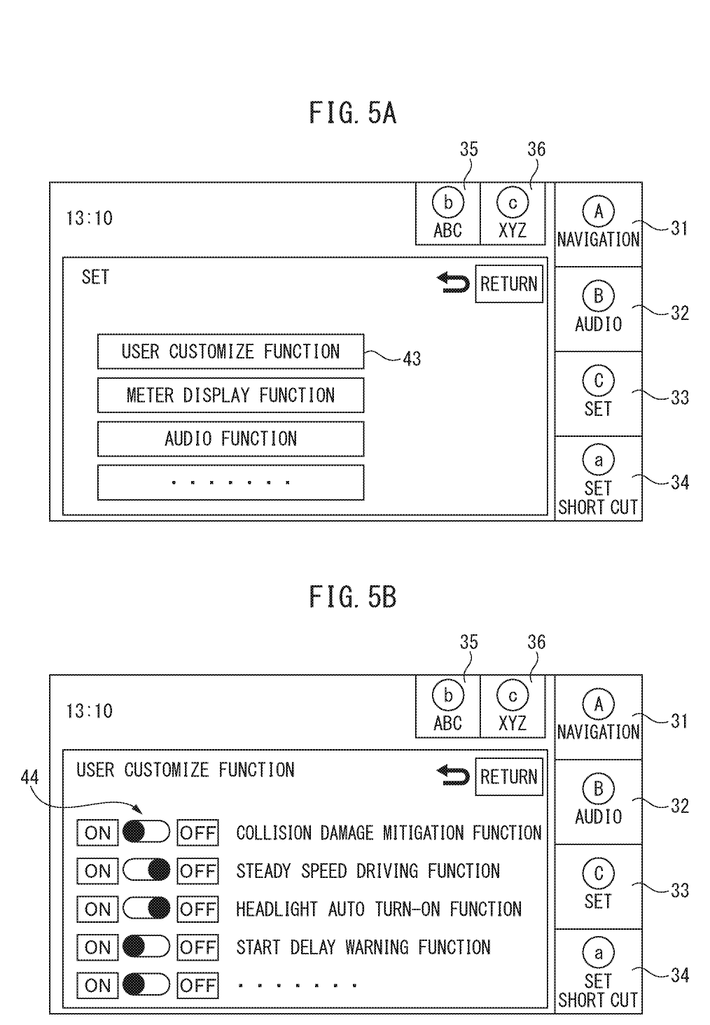

On the other hand, when, for example, the road map is displayed on the basic screen of the display device 21 such as shown in FIG. 3A, if the setting button 33 is touched, the road map is switched to the setting screen such as shown in FIG. 5A positioned one level lower. Next, if, for example, a user customize function button 43 displayed on this setting screen is touched, the setting screen is switched to the user customize function selection screen such as shown in FIG. 5B positioned one further level lower. In the example shown in FIG. 5B, an on-off display 44 is displayed on the user customize function selection screen for showing whether respective functions are currently on or off.

Here, if simply explaining the functions displayed on the user customize function selection screen, a collision damage mitigating function is a function of using the braking device 11 to impart a braking force to the vehicle 1 when a state where the vehicle 1 approaches another vehicle from the rear is detected by the detection device 18, a steady speed driving function is a function of making the vehicle 1 run at a steady speed which is set, a headlight auto turn-on function is a function of automatically turning on the headlights when the brightness of the surroundings becomes a threshold value or less, and a start delay warning function is a function of issuing a warning when for example the vehicle 1 continues to be stopped despite another vehicle stopped in front of the vehicle 1 starting to move. Note that, in FIGS. 5A and FIG.5B, the expression “…….” means there is a description, but details of the description are omitted. The same is true below.

That is, the functions described in FIG. 5B are just part of the functions listed on the user customize function selection screen. In actuality, the user customize function selection screen displays a far greater number of functions. In FIG. 5B, for example, if focusing on the headlight auto turn-on function, currently the headlight auto turn-on function is deactivated as will be understood from the on/off display 44. That is, the headlight auto turn-on function is set off. In this case, if touching the ON button of the headlight auto turn-on function, the headlight auto turn-on function changes from the off setting to the on setting and the on/off display 44 changes to show an on setting. In this way, in this example, by touching the corresponding button on the user customize function selection screen positioned at the deepest level, it is possible to switch all of the functions from the off setting to the on setting or switch them from the on setting to the off setting.

In this way, the buttons for setting functions on or setting them off are positioned at the deep level. However, in this way, if buttons are positioned at the deep level, time is taken for operating the buttons. In particular, if buttons of functions often utilized by a user are positioned at the deep level, for the user, operation of the button becomes considerably burdensome. Therefore, to lighten the burden on the user, in an embodiment according to the present disclosure, as shown in FIG. 3A, two short cut buttons 35, 36 for operation to which respectively different functions are assigned are displayed on the basic screen of the display device 21. Of course, three or more of such short cut buttons can also be displayed, but below, an embodiment according to the present disclosure will be explained with reference to an example of a case where two short cut buttons 35, 36 are displayed. Note that, in FIG. 3A, the marks “b”, “c” and letters ABC, XYZ schematically show icons.

In an embodiment according to the present disclosure, if touching the short cut button 35, when the function assigned to the short cut button 35 is currently set off, it is switched to an on setting. Due to this, the function assigned to the short cut button 35 is activated. Next, if touching the short cut button 35 one more time, the function assigned to the short cut button 35 is switched from the on setting to the off setting whereupon the function assigned to the short cut button 35 is deactivated. That is, each time touching the short cut button 35, the on setting and off setting of the function are switched whereupon activation of the function and deactivation of the function are switched.

Similarly, if touching the short cut button 36, when the function assigned to the short cut button 36 is currently set off, it is switched to an on setting. Due to this, the function assigned to the short cut button 36 is activated. Next, if touching the short cut button 36 one more time, the function assigned to the short cut button 36 is switched from the on setting to the off setting whereupon the function assigned to the short cut button 36 is deactivated. That is, each time touching the short cut button 36, the on setting and off setting of the function are switched whereupon activation of the function and deactivation of the function are switched.

Further, in an embodiment according to the present disclosure, if touching the short cut button 35, when the function assigned to the short cut button 35 is set off, the short cut button 35 is rendered off in display, while if the function assigned to the short cut button 35 is set on, the short cut button 35 is rendered on in display. Similarly, when the function assigned to the short cut button 36 is set off, the short cut button 36 is rendered off in display, while if the function assigned to the short cut button 36 is set on, the short cut button 36 is rendered on in display.

An example when the short cut button 35 is rendered off in display and when the short cut button 35 is rendered on in display is shown in FIGS. 3A and FIG. 3B. In this example, when the short cut button 35 is the same brightness as the other buttons 31, 32, and 33 as shown in FIG. 3A, the display of the short cut button 35 is deemed off in display while when the short cut button 35 as a whole shines brightly or when the icon part of the short cut button 35 shines brightly as shown in FIG. 3B, the short cut button 35 is deemed on in display. Similarly, when the short cut button 36 is the same brightness as the other buttons 31, 32, and 33, the short cut button 36 is deemed off in display, while when the short cut button 36 as a whole shines brightly or when the icon part of the short cut button 36 shines brightly, the short cut button 36 is deemed on in display.

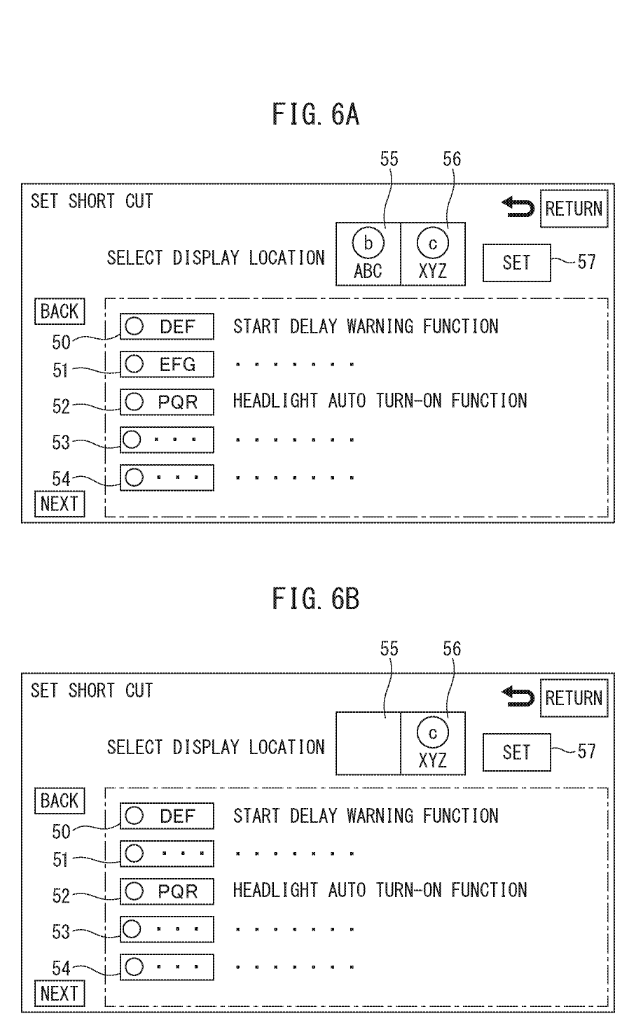

Further, in an embodiment according to the present disclosure, to assign functions to the short cut buttons 35, 36, as shown in FIGS. 3A and FIG. 3B, a short cut setting button 34 is displayed on the basic screen of the display device 21. In this case, for example, if the short cut setting button 34 is touched when the road map is displayed on the basic screen of the display device 21 as shown in FIG. 3A, the road map is switched to a short cut setting screen positioned at one lower level such as shown in FIG. 6A. In the example shown in FIG. 6A, candidates of functions able to be assigned to the short cut buttons 35, 36 are displayed on the short cut setting screen. Furthermore, for the candidates of the functions displayed, the short cut setting buttons 50, 51, 52, 53, and 54 are respectively displayed. Icons comprised of marks and letters are displayed on the short cut setting buttons 50, 51, 52, 53, and 54.

Note that, the candidates of the functions shown in FIG. 6A, that is, the start delay warning function and headlight auto turn-on function are just some of the candidates of functions listed on the short cut setting screen. In actuality, a far greater number of candidates of functions are displayed on the short cut setting screen. In this case, in the example shown in FIG. 6A, numerous candidates of functions are displayed over several pages. Further, in the example shown in FIG. 6A, the short cut setting buttons 50, 51, 52, 53, 54 of the candidates of functions which are set on, that is, the candidates of the functions which are activated are rendered on in display, and the short cut setting buttons 50, 51, 52, 53, 54 of the candidates of functions which are set on shine brightly as a whole or the icon parts of the short cut setting buttons 50, 51, 52, 53, 54 shine brightly. The functions to be assigned to the short cut buttons 35, 36 displayed on the basic screen of the display device 21 are selected by the user of the vehicle 1 from among the candidates of functions listed on this short cut setting screen.

Further, in the example shown in FIG. 6A, display location selection buttons 55 and 56 for selecting one of the two short cut buttons 35, 36 displayed on the basic screen of the display device 21 to which the function selected by the user of the vehicle 1 should be assigned are displayed on the short cut setting screen. In this case, the display location selection buttons 55 and 56 are provided so that it is understood that the short cut button 35 displayed on the basic screen of the display device 21 corresponds to the display location selection button 55 displayed on the short cut setting screen while the short cut button 36 displayed on the basic screen of the display device 21 corresponds to the display location selection button 56 displayed on the short cut setting screen. In this case, in the example shown in FIG. 6A, the short cut button 35 and the display location selection button 55 are displayed by the same icon while the short cut button 36 and the display location selection button 56 are displayed by the same icon. In this case, if no function is assigned to, for example, the short cut button 35, as will be understood from FIG. 6B, no icon is displayed at the display location selection button 55.

For example, when the user of the vehicle 1 desires to assign the headlight auto turn-on function to the short cut button 35, if the user touches the short cut setting button 52 of the headlight auto turn-on function, then touches the display location selection button 55, then touches the setting button 57, the headlight auto turn-on function is assigned to the short cut button 35. If the headlight auto turn-on function is assigned to the short cut button 35, the display and icon of the function which had been assigned to the short cut button 35 up to then are returned to the short cut setting screen and an icon showing the headlight auto turn-on function is displayed on the short cut button 35. If the headlight auto turn-on function finishes being assigned to the short cut button 35, after that, it becomes possible to switch between the on setting and off setting of the headlight auto turn-on function by just touching the short cut button 35 displayed on the basic screen of the display device 21.

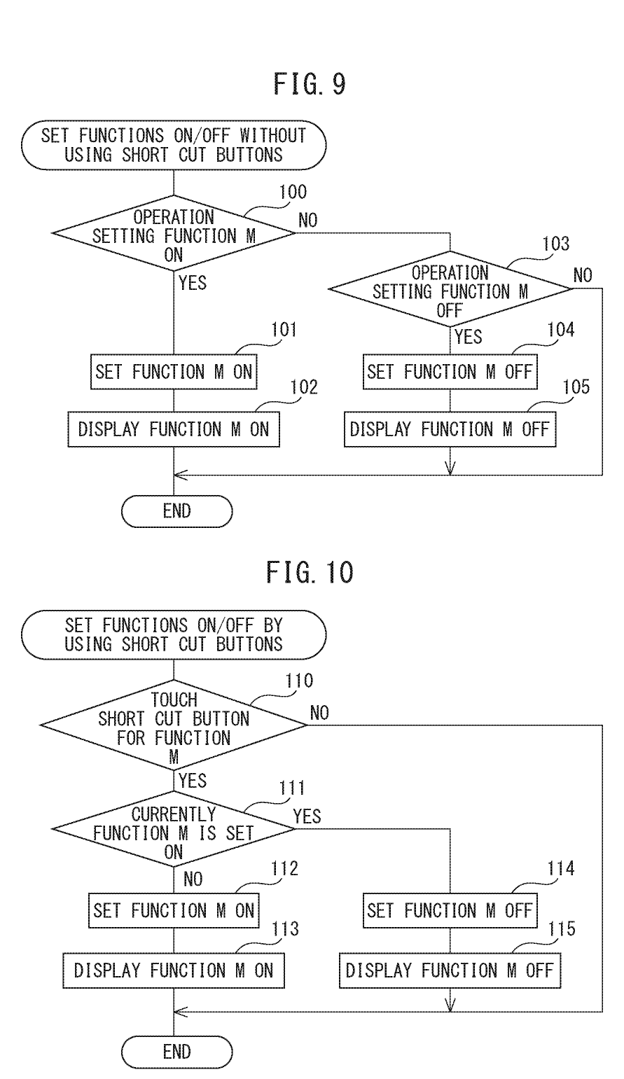

Next, referring to FIGS. 9 to FIG. 11, the routine for performing processing for setting functions on/off without using the short cut buttons 35, 36, the routine for performing processing for setting functions on/off by using the short cut buttons 35, 36, and the flow of assigning functions to the short cut buttons 35, 36 will be successively explained. FIG. 9 is a flow chart for performing processing for setting functions on/off without using short cut buttons 35, 36, and FIG. 10 is a flow chart for performing processing for setting functions on/off by using short cut buttons 35, 36. The routines shown in FIGS. 9 and FIG. 10 are provided for each function and these routines are repeatedly performed in the electronic control unit 13. Note that, a program for performing each function is stored in advance in the memory 16 of the electronic control unit 13.

Referring to the routine for performing the processing for setting functions on/off without using the short cut buttons 35, 36, first, at step 100, it is judged whether an operation requesting activation of the function M, that is, an operation for setting the function M on has been performed by the user. For example, when the user touches the parking lot button 42 in FIG. 4B, it is judged that an operation requesting activation of the parking lot position display function for displaying positions of parking lots on the road map has been performed, that is, an operation for setting the parking lot position display function on has been performed. In this case, the function M indicates the parking lot position display function. Further, when the user touches the ON button of the headlight auto turn-on function in FIG. 5B, it is judged that an operation requesting activation of the headlight auto turn-on function for making the headlights automatically turn on when the brightness of the surroundings becomes a threshold value or less has been performed, that is, an operation for setting the headlight auto turn-on function on has been performed. In this case, the function M indicates the headlight auto turn-on function.

When, at step 100, it is judged that an operation requesting activation of the function M, that is, an operation for setting the function M on has been performed by the user, the routine proceeds to step 101 where the function M is set on and the function M is activated. At this time, if the function M is the parking lot position display function, the parking lot position display function for displaying positions of parking lots on the road map is performed, while if the function M is the headlight auto turn-on function, the headlight auto turn-on function for making the headlights automatically turn on is performed. If the function M is set on, as shown at step 102, the function M is rendered on in display. At this time, the on/off display switch 44 of the function M shown in FIG. 5B is switched from “display off” to “display on” while the short cut setting button of the candidates of the function M shown in FIG. 6A etc. is switched from “display off” to “display on”. If the short cut button for the function M is being displayed, the short cut button for the function M is switched from an “display off” to “display on”.

As opposed to this, when at step 100, it is judged that an operation requesting activation of the function M, that is, an operation for setting the function M on has not been performed by the user, the routine proceeds to step 103 where it is judged whether an operation for deactivation of the function M, that is, an operation for setting the function M off has been performed by the user. For example, when the positions of parking lots are displayed on the road map, if the user touches the button 31 of the navigation function, it is judged that an operation for deactivation of the parking lot position display function, that is, an operation for setting the parking lot position display function off has been performed. In this case, the “function M” indicates the parking lot position display function. Further, when the user touches the OFF button of the headlight auto turn-on function in FIG. 5B, it is judged that an operation for stopping activation of the headlight auto turn-on function has been performed, that is, an operation for setting the headlight auto turn-on function off has been performed. In this case, the “function M” indicates the headlight auto turn-on function.

When at step 103, it is judged that an operation for deactivation of the function M, that is, an operating for setting the function M off has been performed by the user, the routine proceeds to step 104 where the function M is set off and the function M is deactivated. At this time, if the function M is the parking lot position display function, display of the positions of parking lots on the road map is stopped, and if the function M is the headlight auto turn-on function, the headlight auto turn-on function for making the headlights automatically turn on is deactivated. If the function M is set off, as shown in step 105, the function M is rendered off in display. At this time, the on/off display switch 44 for the function M shown in FIG. 5B is switched from “display on” to “display off” while the short cut setting button of the candidates of the function M shown in FIG. 6A etc. is switched from “display on” to “display off”. If the short cut button for the function M is displayed, the short cut button for the function M is switched from “display on” to “display off”. On the other hand, if, at step 103, it is judged that an operation for setting the function M off has not been performed by the user, the processing cycle is ended.

FIG. 10 shows a routine for performing processing for setting functions on/off by using the short cut buttons 35, 36. If explaining FIG. 10 with reference to the example of the case where the function M is assigned to one of the short cut buttons 35, 36, for example, the short cut button 35, first, at step 110, it is judged whether the short cut button 35 to which the function M has been assigned has been touched. When it is judged that the short cut button 35 has been touched, the routine proceeds to step 111 where it is judged whether currently the function M is set on, that is, whether the function M is activated. When it is judged that the function M is set off, that is, when it is judged that function M is deactivated, the routine proceeds to step 112.

At step 112, the function M is set on and the function M is activated. At this time, if the function M is the parking lot position display function, the parking lot position display function for displaying the positions of parking lots on the road map is performed, while in the case where the function M is the headlight auto turn-on function, the headlight auto turn-on function for making the headlights automatically turn on is performed. If the function M is set on, as shown at step 113, the function M is rendered on in display. At this time, the short cut setting button of the candidates for the function M shown in FIG. 6A etc. is switched from “display off” to “display on”, the on/off display switch 44 of the function M shown in FIG. 5B is switched from “display off” to “display on”, and the short cut button 35 is switched from “display off” to “display on”.

On the other hand, when, at step 111, it is judged that the function M is currently set on, that is, the function M is activated, the routine proceeds to step 114 where the function M is set off and the function M is deactivated. At this time, if the function M is the parking lot position display function, the display of the parking lot positions on the road map is stopped, while if the function M is the headlight auto turn-on function, the headlight auto turn-on function for making the headlights automatically turn on is deactivated.

If the function M is set off, as shown at step 115, the function M is rendered off in display. At this time, the short cut setting button of the candidates of the function M shown in FIG. 6A etc. is switched from “display on” to “display off”, the on/off display switch 44 of the function M shown in FIG. 5B is switched from “display on” to “display off”, and the short cut button 35 is switched from “display on” to “display off”. On the other hand, when at step 110, it is judged that the short cut button 35 has not been touched, the processing cycle is ended.

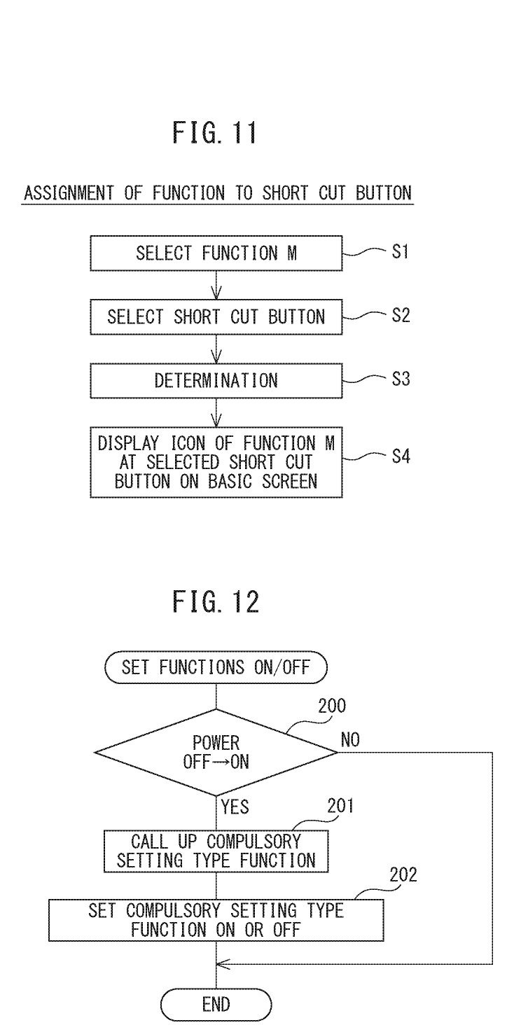

Referring to FIG. 11 showing the flow of assignment of functions to the short cut buttons, first, as shown at S1, the function M which the user desires to assign to the short cut button 35, 36 is selected from among the large number of candidates for functions listed on the short cut setting screen shown in FIG. 6A. Therefore, this short cut setting screen configures the function selection screen. In this case, the function M is selected by touching the short cut setting button 50, 51, 52, 53, 54 of the candidate of the function which the user desires to assign to the short cut button 35, 36. Next, as shown in S2, the short cut button 35, 36 to which the function M is desired to be assigned is selected. The short cut button 35, 36 is selected by touching either of the display location selection buttons 55 and 56 in FIG. 6A.

Next, as shown at S3, the short cut button 35, 36 to which the function M is assigned is determined as the selected short cut button 35, 36. This determination is performed by touching the setting button 57 on the short cut setting screen shown in FIG. 6A. If touching the setting button 57, as shown in S4, the function M is assigned to the selected short cut button 35, 36 on the basic screen of the display device 21 instead of the function which had been assigned up to then and an icon showing the function M is displayed on the selected short cut button 35, 36. The function which had been assigned up to then to the selected short cut button 35, 36 and icon are again displayed at the location of the short cut setting screen where they had originally been displayed.

In this way, in an embodiment according to the present disclosure, the short cut buttons 35, 36 are displayed on the basic screen of the display device 21, and it is possible to set the functions respectively assigned to the short cut buttons 35, 36 on/off by just touching the short cut buttons 35, 36. Therefore, it is possible to lessen the burden felt by the user when setting the functions on/off. Here, the issue becomes which functions should be assigned to the short cut buttons 35, 36 to enable the burden felt by the user to be more effectively lessened. Therefore, next, the functions desirably assigned to the short cut buttons 35, 36 will be studied.

Functions come in two types. The first type of function is a function which is set on when the power of the vehicle 1 is turned on whether the function was set on or set off when the power of the vehicle 1 was turned off the previous time or a function which is set off when the power of the vehicle 1 is turned on whether the function was set on or set off when the power of the vehicle 1 was turned off the previous time, that is, a function which is compulsorily set on or off when the power of the vehicle 1 is turned on regardless of the on/off setting of the function when the power was turned off the previous time. The second type of function is a function which is set on when the power of the vehicle is turned on if the function was set on when the power of the vehicle 1 was turned off the previous time and which is set off when the power of the vehicle 1 is turned on if the function was set off when the power of the vehicle 1 was turned off the previous time, that is, a function where an on/off setting of the function when the power was turned off the previous time are held when the power of the vehicle 1 is turned on.

Note that, in this Description, the first type of function, that is, a function which is compulsorily set on or off when the power of the vehicle 1 is turned on regardless of the on/off setting of the function when the power was turned off the previous time is called a “compulsory setting type of function”, while the second type of function, that is, a function where an on/off setting of the function when the power was turned off the previous time are held when the power of the vehicle 1 is turned on is called a “setting holding type of function”. For all functions, whether the function is the compulsory setting type function or is the setting hold type function is stored in the memory 16 of the electronic control unit 13, and if the function is the compulsory setting type function, whether to set the function on or whether to set it off when the power of the vehicle 1 is turned on is stored in the memory 16 of the electronic control unit 13.

FIG. 12 shows a routine for performing processing for setting on/off of a compulsory setting type function when the power is turned on. This routine is performed repeatedly in the electronic control unit 13.

Referring to FIG. 12, first, at step 200, it is judged whether the power is switched from off to on. When it is judged that the power is switched from off to on, the routine proceeds to step 201 where all of the compulsory setting type functions are called up from the functions stored in the memory 16. Next, at step 202, all of the compulsory setting type functions are respectively set on or set off based on the information stored in the memory 16.

Now then, usually, most of the functions are made setting hold type functions while some of the functions are made compulsory setting type functions. In this case, the compulsory setting type functions sometimes are felt by the user to be burdensome. For example, assuming that the start delay warning function is made the compulsory setting type function which is compulsorily set on when the power of the vehicle 1 is turned on regardless of the on/off setting of the function when the power was turned off the previous time, when the power of the vehicle 1 is turned on, the start delay warning function is automatically set on.

Therefore, if the user of the vehicle 1 wants to set the start delay warning function off, it becomes necessary to switch the start delay warning function from the on setting to the off setting each time the power of the vehicle 1 is turned on. This is burdensome to the user. In this case, for example, if the start delay warning function is assigned to the short cut button 35, it is possible to switch the start delay warning function from the on setting to the off setting by just touching the short cut button 35, so it is possible to lessen the burden which the user feels. Note that, the function of assigning a function to the short cut buttons 35, 36 are made the setting hold type functions, so once the start delay warning function is assigned to the short cut button 35, after that, the start delay warning function is automatically assigned to the short cut button 35 each time the power of the vehicle 1 is turned on. Therefore, by just touching the short cut button 35 each time the power of the vehicle 1 is turned on, it is possible to switch the start delay warning function from the on setting to the off setting.

In this way, once the start delay warning function is assigned to the short cut button 35, after that, it is possible to lessen the burden which the user feels. In this case, the user feels burdened when first assigning the start delay warning function to the short cut button 35. When first assigning the start delay warning function to the short cut button 35, as explained above, the short cut setting button 34 displayed on the basic screen of the display device 21 is touched. Next, the start delay warning function which the user desires to assign to the short cut button 35 or 36 is selected from among the large number of candidates of functions listed on the short cut setting screen shown in FIG. 6A. Next, the short cut setting button 50 of the start delay warning function is touched. Next, the short cut button 35 or 36 to which the start delay warning function is desired to be assigned is selected.

In embodiments, in this case, to lessen the burden which the user feels, the compulsory setting type functions are preferentially selected from among all functions and displayed on the short cut setting screen so that the start delay warning function, that is, the compulsory setting type function which the user desires to be assigned to the short cut button 35 or 36 can be easily selected. Furthermore, in embodiments, when the compulsory setting type functions are displayed on the short cut setting screen, the compulsory setting type functions are displayed in a form able to be more easily found compared with a display of setting hold type functions. Therefore, in an embodiment according to the present disclosure, provision is made of a function assigning unit for making a plurality of candidates for functions to be assigned to short cut buttons 35, 36 be displayed on the function selection screen of the display device 21, that is, the short cut setting screen shown in FIGS. 6A and FIG. 6B, and making the user select the functions to be assigned to the short cut buttons 35, 36. Furthermore, as the candidates of the functions, the compulsory setting type functions are selected preferentially, and by the function assigning unit, the compulsory setting type functions are preferentially made to be displayed as the candidates of functions on the function selection screen, that is, the short cut setting screen shown in FIGS. 6A and FIG. 6B. Note that, in this case, the electronic control unit 13 configures this function assigning unit.

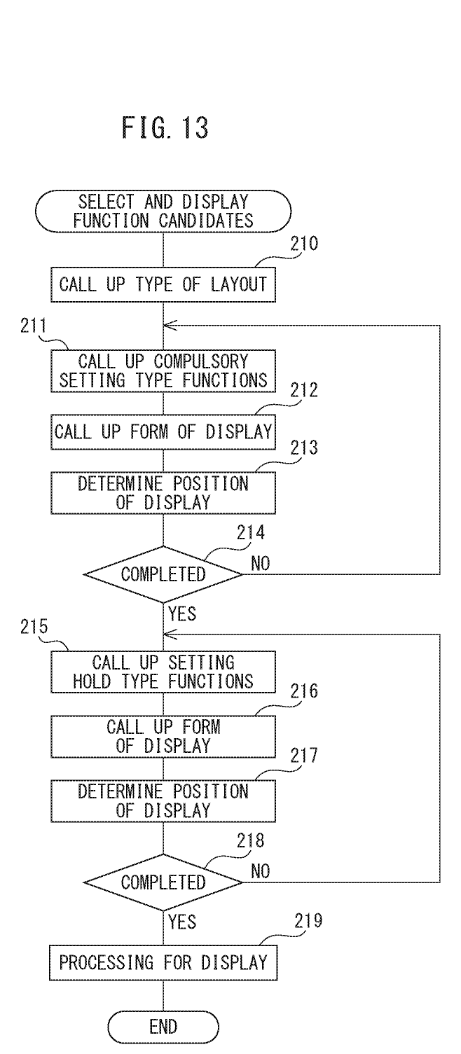

FIG. 13 shows the routine for processing for selection and display of candidates of functions for selecting the candidates of functions and displaying them on the function selection screen of the display device 21, that is, the short cut setting screen shown in FIG. 6A and FIG. 6B. This routine is performed in the electronic control unit 13. Referring to FIG. 13, first, at step 210, the type of layout of listing of function candidates when the function candidates are listed is called up from the memory 16 of the electronic control unit 13. The type of layout of listing the function candidates is stored inside the memory 16 of the electronic control unit 13.

Next, at step 211, one of the compulsory setting type functions is called up from the memory 16 of the electronic control unit 13. Note that, all of the functions and whether, for all of the functions, the functions are compulsory setting type functions or setting hold type functions are stored in the memory 16 of the electronic control unit 13. Next, at step 212, the form of display of the called up compulsory setting type function is called up from the memory 16 of the electronic control unit 13. Note that, the form of display of the compulsory setting type function, that is, the display of letters for the function, the display of an icon for the function, and the size of the letters and icon are stored in the memory 16 of the electronic control unit 13. Next, at step 213, the position of display of the compulsory setting type function at the layout of listing of the function candidates is determined. Next, at step 214, it is judged if all of the compulsory setting type functions have finished being called up. When it is judged that all of the compulsory setting type functions have not finished being called up, the routine returns to step 211. The forms of display and positions of display for all of the compulsory setting type functions are determined in this way.

When it is judged at step 214 that all of the compulsory setting type functions have finished being called up, the routine proceeds to step 215 where one of the setting hold type functions is called up from the memory 16 of the electronic control unit 13. Next, at step 216, the form of display of the called up setting hold type function is called up from the memory 16 of the electronic control unit 13. Note that, the form of display of the setting hold type function, that is, the display of letters of the function, the display of an icon of the function, and the sizes of the letters or icon are stored in the memory 16 of the electronic control unit 13. Next, at step 217, the position of display of the setting hold type function at the layout of list of the function candidates is determined. Next, at step 218, it is judged if a preset number of setting hold type functions or a number of setting hold type functions which falls inside the layout of listing of function candidates have finished being called up. When it is judged that a preset number of setting hold type functions or a number of setting hold type functions which falls inside the layout of listing of function candidates have not finished being called up, the routine returns to step 215. The forms of display and positions of display for a preset number of setting hold type functions or a number of setting hold type functions which falls inside the layout of listing of function candidates are determined in this way.

When at step 218 it is judged that a preset number of setting hold type functions or a number of setting hold type functions which falls inside the layout of listing of function candidates have finished being called up, the routine proceeds to step 219 where the form of display and positions of display determined are used to display the compulsory setting type functions and setting hold type functions on the function selection screen of the display device 21, that is, the short cut setting screens of FIGS. 6A and FIG. 6B, as the candidates of functions. In this way, in an embodiment according to the present disclosure, as the candidates of functions, the compulsory setting type functions are preferentially selected. As a result, as the candidates of functions, the compulsory setting type functions are preferentially displayed on the function selection screen of the display device 21, that is, the short cut setting screen shown in FIGS. 6A and FIG. 6B.

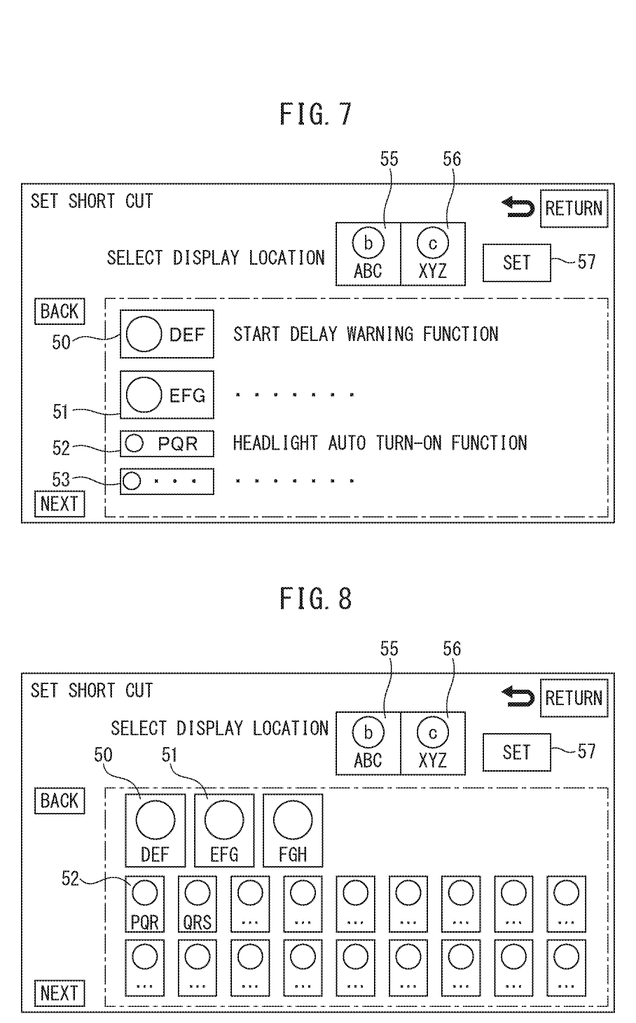

FIGS. 6A, FG. 7, and FIG. 8 show several examples of forms of display of the compulsory setting type functions and forms of display of the setting hold type functions. In the example shown in FIG. 6A, a large number of functions are displayed on the short cut setting screen, that is, function selection screen, divided into several pages and, to enable the compulsory setting type function which a user desires to assign to the short cut button 35, 36, for example, the start delay warning function, to be easily selected, the start delay warning function, that is, compulsory setting type function, is displayed on the first page. On the other hand, in the example shown in FIG. 7, icons of the functions are displayed on the short cut setting screen, that is, the function selection screen and, to enable the compulsory setting type functions which a user desires to assign to the short cut buttons 35, 36, for example, the start delay warning function, to be easily selected, the icon of the start delay warning function, that is, the compulsory setting type functions, is displayed larger than the icon of the setting hold type function, for example, the icon of the headlight auto turn-on function. Further, in the example shown in FIG. 8, a plurality of icons of the functions are displayed aligned vertically and horizontally on the short cut setting screen, that is, function selection screen and, to enable compulsory setting type functions which a user desires to assign to the short cut buttons 35, 36, for example, the start delay warning function, to be easily selected, the icon of the start delay warning function, that is, compulsory setting type functions, is displayed at the topmost row.

In this way, in an embodiment according to the present disclosure, there is provided a display control device for controlling a screen display of the display device 21 mounted in the vehicle 1, the display control device comprising a short cut button display control unit for making short cut buttons 35, 36 be displayed on the basic screen of the display device 21 and a function assigning unit for making a plurality of candidates for functions to be assigned to the short cut buttons 35, 36 be displayed on the function selection screen of the display device 21 and making a user select functions to be assigned to the short cut buttons 35, 36. The plurality of functions displayed on the function selection screen are comprised of either compulsory setting type functions which are compulsorily set on or off when the power of the vehicle 1 is turned on regardless of the on/off settings of the functions when the power was turned off the previous time and setting hold type functions where the on/off settings of the functions when the power was turned off the previous time are held when the power of the vehicle 1 is turned on. The function assigning unit makes compulsory setting type functions be preferentially displayed as the candidates of functions on the function selection screen.

Further, in an embodiment according to the present disclosure, there is provided a display control method for controlling a screen display of a display device mounted in a vehicle, the display control method causing a computer to make short cut buttons 35, 36 be displayed on a basic screen of the display device 21 and make a plurality of candidates for functions to be assigned to the short cut buttons 35, 36 be displayed on a function selection screen of the display device 21 and make a user select functions to be assigned to the short cut buttons 35, 36. The plurality of functions displayed on the function selection screen are comprised of either compulsory setting type functions which are compulsorily set on/off when the power of the vehicle 1 is turned on regardless of the on/off settings of the functions when the power was turned off the previous time and setting hold type functions where the on/off settings of the functions when the power was turned off the previous time are held when the power of the vehicle 1 is turned on. The compulsory setting type functions are preferentially displayed as candidates of functions on the function selection screen.

Further, in an embodiment according to the present disclosure, there is provided a program or a program product used for controlling a screen display of the display device 21 mounted in the vehicle 1, the program or the program causing a computer to make short cut buttons 35, 36 be displayed on a basic screen of the display device 21 and make a plurality of candidates for functions to be assigned to the short cut buttons 35, 36 be displayed on a function selection screen of the display device 21 and make a user select the function to be assigned to the short cut button 35, 36. The plurality of functions displayed on the function selection screen are comprised of either compulsory setting type functions which are compulsorily set on or off when the power of the vehicle is turned on regardless of the on/off settings of the functions when the power was turned off the previous time and setting hold type functions where the on/off settings of the functions when the power was turned off the previous time are held when the power of the vehicle is turned on. The compulsory setting type functions are preferentially displayed as candidates of functions on the function selection screen.

Further, in an embodiment according to the present disclosure, the function assigning unit displays the compulsory setting type functions and setting hold type functions on the function selection screen in a form enabling display of the compulsory setting type functions to be found more easily compared with display of the setting hold type functions so that a user can easily select the compulsory setting type function from among the candidates of the functions. Further, in an embodiment according to the present disclosure, the function assigning unit displays candidates of functions on the function selection screen divided into several pages and displays the compulsory setting type functions on the first page. Further, in an embodiment according to the present disclosure, the function assigning unit displays icons of the candidates of the functions on the function selection screen and displays icons of the compulsory setting type functions larger than icons of the setting hold type functions.

Further, in an embodiment according to the present disclosure, the function assigning unit displays a plurality of icons of the candidates of the functions on the function selection screen aligned vertically and horizontally and displays icons of the compulsory setting type functions at the topmost row. Furthermore, in an embodiment according to the present disclosure, the compulsory setting type function is a function automatically turned on when the power of the vehicle 1 is turned on. Furthermore, in an embodiment according to the present disclosure, the short cut buttons 35, 36 are formed so that functions assigned to the short cut buttons are switched between the on setting and off setting each time the short cut buttons 35, 36 are touched.

Further, in an embodiment according to the present disclosure, the display control device is constructed so that, when the power of the vehicle 1 is turned on, for example, the start delay warning function which is the compulsory setting type function is set on and, when the start delay warning function is set off by touching the short cut button 35, 36 assigned to the start delay warning function, the short cut button 35, 36 for the start delay warning function is not allowed to be displayed on the basic screen of the display device 21 until the power of the vehicle 1 is turned off. That is, when the power of the vehicle 1 is turned on, the start delay warning function is set on and then the start delay warning function is set off, the possibility of the short cut button 35, 36 for the start delay warning function being touched is extremely low. Therefore, almost no problem arises even if stopping display of the short cut button 35, 36 assigned to the start delay warning function. As opposed to this, if stopping display of the short cut button 35, 36 assigned to the start delay warning function, the number of short cut buttons 35, 36 displayed is decreased, so there is an aspect that display of the short cut buttons 35, 36 assigned to other functions becomes easier to recognize.

In this way, in this embodiment, expressed comprehensively, if the compulsory setting type functions are assigned by the function assigning unit as functions to be assigned to the short cut buttons 35, 36, the short cut button display control unit does not allow the short cut buttons 35, 36 for the compulsory setting type functions to be displayed on the basic screen of the display device 21 until the power of the vehicle 1 is turned off when the on/off setting for the compulsory setting type functions is changed by the user after turning on the power of the vehicle 1 and before turning off the power of the vehicle 1.

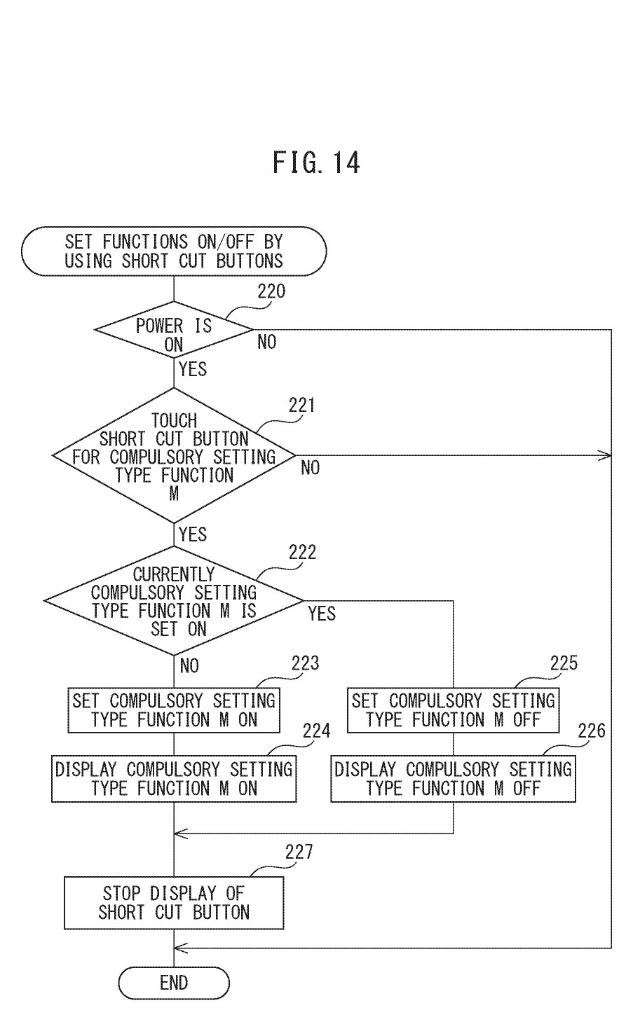

FIG. 14 shows the routine for working this embodiment. This routine is repeatedly performed in the electronic control unit 13. Note that, this routine is used added to the routine for processing for on/off setting of the functions by using the short cut buttons 35, 36 shown in FIG. 10. Referring to FIG. 14, first, at step 220, it is judged if the power of the vehicle 1 is turned on. When it is judged that the power of the vehicle 1 is turned off, the processing cycle ends. As opposed to this, when it is judged that the power of the vehicle 1 is turned on, the routine proceeds to step 221 where it is judged whether the short cut button 35 to which the compulsory setting type function M such as, for example, the start delay warning function is assigned has been touched. When it is judged that the short cut button 35 has been touched, the routine proceeds to step 222 where it is judged if currently the compulsory setting type function M is set on, that is, the compulsory setting type function M is activated. When it is judged that the compulsory setting type function M is set off, that is, when it is judged that the compulsory setting type function M is deactivated, the routine proceeds to step 223.

At step 223, the compulsory setting type function M is set on and the compulsory setting type function M is activated. At this time, if the compulsory setting type function M is the start delay warning function, the start delay warning function is performed. If the compulsory setting type function M is set on, as shown in step 224, the compulsory setting type function M is rendered “display on”. At this time, the short cut setting button of the candidate for the compulsory setting type function M shown in FIG. 6A etc. is switched from “display off” to “display on”, the on/off display switch 44 of the compulsory setting type function M shown in FIG. 5B is switched from “display off” to “display on”, and the short cut button 35 is switched from “display off” to “display on”. Next, the routine proceeds to step 227 where the display of the short cut button 35 to which the compulsory setting type function is assigned on the basic screen of the display device 21 is stopped.

On the other hand, when, at step 222, it is judged that the compulsory setting type function M is currently set on, that is, the compulsory setting type function M is activated, the routine proceeds to step 225 where the compulsory setting type function M is set off and the compulsory setting type function M is deactivated. At this time, if the compulsory setting type function M is the start delay warning function, the start delay warning function is deactivated. If the compulsory setting type function M is set off, as shown at step 226, the compulsory setting type function M is rendered “display off”. At this time, display of the short cut setting buttons for the candidates of the compulsory setting type functions M shown in FIG. 6A etc. is switched from on to off, the on/off display switch 44 for the compulsory setting type function M shown in FIG. 5B are switched from “display on” to “display off”, and the short cut button 35 is switched from “display on” to “display off”.

Next, the routine proceeds to step 227 where display of the short cut button 35 to which the compulsory setting type function is assigned on the basic screen of the display device 21 is stopped. On the other hand, when, at step 221, it is judged that the short cut button 35 has not been touched, the processing cycle ends. In this way, in this embodiment, when the short cut button 35 is touched, the display of the short cut button 35 on the basic screen of the display device 21 is stopped. Note that, in this case, without stopping the display of the short cut button 35, the function assigned to the short cut button 35 is changed from the compulsory setting type function which had been assigned to the short cut button 35 up to then to, for example, another function with a high frequency of use.

1. A display control device for controlling a screen display of a display device mounted in a vehicle, the display control device comprising:
a short cut button display control unit for making short cut buttons be displayed on a basic screen of the display device and
a function assigning unit for making a plurality of candidates for functions to be assigned to the short cut buttons be displayed on a function selection screen of the display device and making a user select the functions to be assigned to the short cut buttons,
a plurality of the functions displayed on the function selection screen being comprised of either compulsory setting type functions which are compulsorily set on or off when a power of the vehicle is turned on regardless of on/off settings of the functions when the power was turned off the previous time and setting hold type functions where the on/off settings of the functions when the power was turned off the previous time are held when the power of the vehicle is turned on,
the function assigning unit making the compulsory setting type functions be preferentially displayed as the candidates of functions on the function selection screen.

2. The display control device according to claim 1, wherein the function assigning unit makes the compulsory setting type functions and the setting hold type functions be displayed on the function selection screen in a form enabling the user to easily find display of the compulsory setting type functions compared with display of the setting hold type functions so that the user can easily select the compulsory setting type functions from among the candidates of functions.

3. The display control device according to claim 1, wherein the function assigning unit makes the candidates of the functions be displayed on the function selection screen divided into a plurality of pages and makes the compulsory setting type functions be displayed on a first page.

4. The display control device according to claim 1, wherein the function assigning unit makes icons of the candidates of the functions be displayed on the function selection screen and makes icons of the compulsory setting type functions be displayed larger than icons of the setting hold type functions.

5. The display control device according to claim 1, wherein the function assigning unit makes a plurality of icons of the candidates of the functions be displayed on the function selection screen aligned vertically and horizontally and makes icons of the compulsory setting type functions be displayed at a topmost row.

6. The display control device according to claim 1, wherein the short cut buttons are formed so that the functions assigned to the short cut buttons are switched between being set on and being set off each time the short cut buttons are touched.

7. The display control device according to claim 1, wherein the compulsory setting type functions are functions which are automatically set on when the power of the vehicle is turned on.

8. The display control device according to claim 1, wherein if the compulsory setting type functions are assigned by the function assigning unit as functions assigned to the short cut buttons, when the on/off setting for the compulsory setting type functions is changed by the user after the power of the vehicle is turned on and before the power of the vehicle is turned off, the short cut button display control unit does not allow the short cut buttons for the compulsory setting type functions to be displayed on the basic screen of the display device until the power of the vehicle is turned off.

9. A display control method for controlling a screen display of a display device mounted in a vehicle, said display control method causing a computer to
make short cut buttons be displayed on a basic screen of the display device,
make a plurality of candidates for functions to be assigned to the short cut buttons be displayed on a function selection screen of the display device and make a user select the functions to be assigned to the short cut buttons, a plurality of the functions displayed on the function selection screen being comprised of either compulsory setting type functions which are compulsorily set on or off when the power of the vehicle is turned on regardless of on/off settings of the functions when the power was turned off the previous time and setting hold type functions where the on/off settings of the functions when the power was turned off the previous time are held when the power of the vehicle is turned on, and
make the compulsory setting type functions be preferentially displayed as the candidates of the functions on the function selection screen.

10. A non-transitory computer-readable storage medium storing a program used for controlling a screen display of a display device mounted in a vehicle, said program causing a computer to
make short cut buttons be displayed on a basic screen of the display device,
make a plurality of candidates for functions to be assigned to the short cut buttons be displayed on a function selection screen of the display device and make a user select the functions to be assigned to the short cut buttons, a plurality of the functions displayed on the function selection screen being comprised of either compulsory setting type functions which are compulsorily set on or off when a power of the vehicle is turned on regardless of on/off settings of the functions when the power was turned off the previous time and setting hold type functions where the on/off settings of the functions when the power was turned off the previous time are held when the power of the vehicle is turned on, and
make the compulsory setting type functions be preferentially displayed as the candidates of the functions on the function selection screen.
